(19) United States
(12) Patent Application Publication
(10) Pub. No.: US 2006/0230117 A1
(43) Pub. Date: Oct. 12, 2006

(54) System and method for message prioritization

(75) Inventors: Deborah C. Gross, Campbell, CA (US); Tim J. Fujita-Yuhas, Seattle, WA (US); Kevin L. Chestnut, Seattle, WA (US)

Correspondence Address: BAKER BOTTS L.L.P., 2001 ROSS AVENUE, SUITE 600, DALLAS, TX, 75201-2980, US

(73) Assignee: CISCO TECHNOLOGY, INC.

(21) Appl. No.: 11/102,061

(22) Filed: Apr. 8, 2005

(51) Int. Cl. G06F 15/16

(52) U.S. Cl. 709/207

(57) ABSTRACT

A method for message prioritization includes receiving a plurality of messages from a plurality of senders. Each of the plurality of messages is directed to a user of a messaging system. Graphical representations of the messages are presented to an assistant of the user, using a graphical user interface. A priority scheme regarding at least a first subset of the plurality of messages is received from the assistant. The method also includes storing the priority scheme.

### TECHNICAL FIELD OF THE INVENTION

This invention relates in general to messaging systems and methods, and more particularly to system and method for message prioritization.

### BACKGROUND OF THE INVENTION

Users of messaging systems are receiving a growing number of messages from voicemail, email, fax, and other communication systems. Executives that travel extensively are particularly affected since the number, type and source of messages is increasing. The time in which an executive has to receive, review and respond to such messages is fixed and limited. Often times, a mobile phone is the only device available to the executive to access and/or respond to these messages. To date, mobile phones and other devices offer limited ways to determine the importance or priority of messages received.

Executives often have an assistant(s) who manages incoming messages. The assistant can screen, delete, delegate and/or respond to messages in order to decrease the overall number of messages that the executive must review. Despite this filtering, the number of messages often remains too high for the executive to handle efficiently.

Attempts have been made to filter messages manually or automatically, using rules or heuristic systems. These efforts have been focused upon text-centric electronic mail messages. Some systems have attempted to prioritize messages based upon message address information, analyses of text content, past actions with similar messages and/or messages to or from the recipient.

Other systems have attempted to prioritize messages based upon action by other message recipients, when the message is directed to more than one recipient. Still others attempt to prioritize messages based upon a scoring technique based, at least in part, upon sender and/or recipient settings for importance.

### SUMMARY OF THE INVENTION

The teachings of the present invention provide a system and method for message prioritization that reduces or eliminates disadvantages and problems associated with prior systems and methods. In accordance with a particular embodiment of the present invention, a method for message prioritization includes receiving a plurality of messages from a plurality of senders. Each of the plurality of messages is directed to a user of a messaging system. Graphical representations of the messages are presented to an assistant of the user, using a graphical user interface. A priority scheme regarding at least a first subset of the plurality of messages is received from the assistant. The method also includes storing the priority scheme. The messages may be reorganized based, at least in part, upon the priority scheme received from the assistant.

In accordance with another embodiment of the present invention, the messages are received at a Unified Messaging System (UMS) and the messages include electronic mail messages and voicemail messages. The voicemail messages may be associated with a plurality of different telephone numbers associated with the user.

In accordance with yet another embodiment of the present invention, the priority scheme may include a numerical ranking of a first subset of the plurality of messages. The plurality of messages may be reorganized according to the priority scheme, including the numerical ranking of the first subset of the plurality of messages. The messages may also be reorganized such that a second subset of the plurality of messages are grouped into a plurality of priority levels. The priority levels may include at least high priority and low priority.

In accordance with still another embodiment of the present invention, the priority scheme may include an indication that particular ones of the messages are personal in nature. The priority scheme may also include an indication that particular ones of the messages require no action on the part of the user. One or more of these indications may be presented to the user, and may include an indication regarding which ones of the messages have previously been reviewed by the assistant.

Technical advantages of particular embodiments of the present invention include a system and method for message prioritization in which an assistant of a user has the ability to log on to the users message account(s) to review, filter and/or prioritize messages manually. This allows the assistant to override any order or priority previously established automatically by a messaging system.

Another technical advantage of particular embodiments of the present invention includes the ability of the assistant to establish the actual order in which at least a subset of the messages are presented to the user. Thus, the assistant may elect to rank the first several messages (e.g., 5-10) to be presented to the user when the user logs on. This is advantageous since the ranking of messages by the assistant is typically more reliable than a ranking established by the messaging system and/or senders of the messages.

Still another technical advantage of particular embodiments of the present invention includes the ability of the assistant to group a subset of the messages according to a plurality of priority levels (e.g., high priority, medium priority, low priority, etc.). Accordingly, the assistant can expeditiously review and prioritize messages to allow for a more efficient review by the user, without necessarily providing a numerical rank to each and every message.

Yet another technical advantage of particular embodiments of the present invention includes the ability of an assistant to provide one or more of a plurality of indicators to messages that are destined for a user. One indicator may include a designation that a particular message is personal in nature, to distinguish the message from business related messages. Another indication may include a designation that a particular message is for information only and/or requires no action on the part of the user. Another indication that may be provided to the user is whether or not a particular message has been previously reviewed by the assistant. One or more of these indicators may be presented to the user, to allow the user to make more informed decisions regarding which messages to review, and in which approximate order to review them.

Yet another technical advantage of particular embodiments of the present invention includes the ability of the assistant to provide an annotation to a particular message, without necessarily changing the order in which the particular message will be presented to the user. Although prior systems allowed for certain annotations to be made to messages, this function typically required that the message be “forwarded” to the user, and it's original position or order was lost. The teachings of the present invention allow such annotations while maintaining the original order, but also allow the assistant to change the order or provide a priority level, for presentation to the user.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system incorporating a messaging system in accordance with a particular embodiment of the present invention;

FIG. 2 illustrates the messaging system of FIG. 1, in accordance with another embodiment of the present invention; and

FIG. 3 illustrates a method for message prioritization, in accordance with yet another embodiment of the present invention.

### DETAILED DESCRIPTION OF THE INVENTION

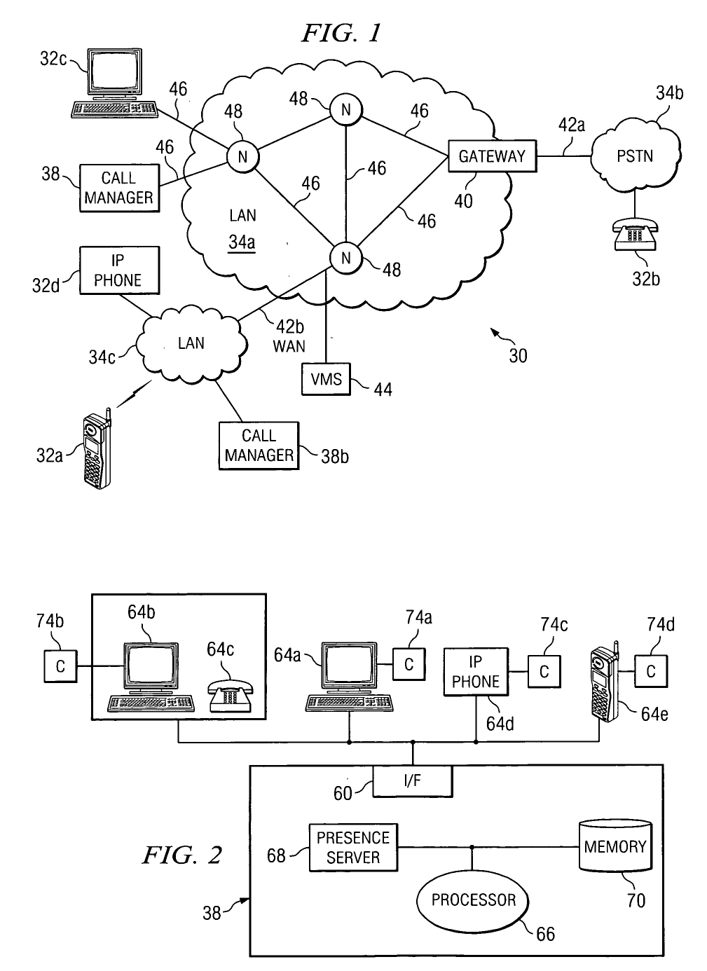

FIG. 1 illustrates a communication system 30 that provides for communication between and among a plurality of endpoints 32a-32d and a messaging system 44, over communication networks 34a-34c. Messaging system 44 is used to collect, record, store, manipulate and/or retrieve messages that are destined for users of networks 34a-34c for example, messages designated for users of endpoints 32a-32d.

In accordance with a particular embodiment of the present invention, a user of messaging system 44 may have several endpoints associated with that user. For example, a single user may have a computer (32c), an office phone (32d), a mobile phone (32a) and a home telephone (32b) associated with that user. Thus, messaging system 44 may be used to obtain messages designated for that user that are addressed to any one or more of endpoints 32a-32d, and store them for later retrieval by the user.

Accordingly, messaging system 44 may be as simple as an answering machine or a voicemail account of the user, and may be more complex, for example a unified messaging system (UMS). A unified messaging system is one that can handle many types and formats of messages designated for the user. Such message types include electronic mail, voicemail, facsimiles, instant messages (IM), text messages, etc.

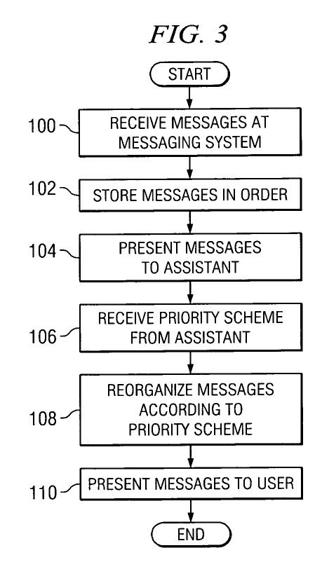

In accordance with a particular embodiment of the present invention, messaging system 44 allows an assistant of the user to access the user's messages (e.g., the user's “account”) and retrieve, review and/or manipulate the messages in a manner that reduces the amount of time that is required of the user to efficiently and effectively review some or all of the user's messages. The manner in which this is accomplished is discussed in more detail with regard to FIG. 3.

It will be recognized by those of ordinary skill in the art that endpoints 32a-32d, call managers 38a-b, and/or gateway 40 may be any combination of hardware, software, and/or encoded logic that cooperate to provide communication services to a user. For example, each endpoint 32a-32d may include a telephone, a computer, a video monitor, a camera, an IP phone, a cell phone, or any other communication hardware, software, and/or encoded logic that supports the communication of packets of media (or frames) using communication networks 34a-34c. Endpoints 32a-32d may also include unattended or automated systems, gateways, other intermediate components, or other devices that can establish media sessions. Although FIG. 1 illustrates a particular number and configuration of endpoints, call managers, segments, nodes, and gateways, communication system 30 contemplates any number or arrangement of such components for communicating media. Furthermore, the endpoints 32 of system 30 may be associated with any number of different users.

In the illustrated embodiment, communication network 34a comprises a local area network (LAN) that couples multiple endpoints 32a-32d for the establishment of communication sessions between a plurality of endpoints 32a-32d distributed across multiple cities and geographic regions. Generally, network 34a provides for the communication of packets, cells, frames, or other portions of information (generally referred to as packets herein) between endpoints 32a-32d. Communication network 34a includes a plurality of segments 46 and nodes 48 that couple endpoint 32a with call managers 38a and 38b, gateway 40, and communication networks 34b-34c. Nodes 48 may include any combination of network components, gatekeepers, call managers, routers, hubs, switches, gateways, endpoints, or other hardware, software, or embedded logic implementing any number of communication protocols that allow for the exchange of packets in communication system 30.

Communication network 34b is a public switched telephone network (PSTN) and couples endpoint 32a with communication network 34a through gateway 40. Communication network 34c is another LAN, which couples endpoints 32a and 32d with communication network 34a. Communication links 42a and 42b couple communication networks 34c and 34b to communication network 34a, respectively. A communication link 42c couples communication networks 34b and 34c. In particular embodiments, communication link 42a is a wide area network (WAN), which couples LANs 34a and 34c.

Although the illustrated embodiment includes three communication networks 34a-34c, the configuration of networks 34a-34c and communication links 42a-42c are provided as merely one example configuration of a system 30 for establishing communication sessions between and among network components. The term “communication network” should be interpreted as generally defining any network capable of transmitting audio and/or video telecommunication signals, data, and/or messages, including signals, data or messages transmitted through text chat, instant messaging and e-mail. Any one of networks 34a-34c may be implemented as a local area network (LAN), wide area network (WAN), global distributed network such as the Internet, Intranet, Extranet, or any other form of wireless or wireline communication network. It is generally recognized that communication networks 34a-34c may include any combination of networks and that system 30 may include fewer or more networks 34a-34c as is required by the number of endpoints 32 or the desired traffic across system 30.

In a particular embodiment, communication network 34a employs voice communication protocols that allow for the addressing or identification of endpoints, nodes, and/or call managers coupled to communication network 34a. For example, using Internet protocol (IP), each of the components coupled together by communication network 34a in communication system 30 may be identified in information directed using IP addresses. In this manner, network 34a may support any form and/or combination of point-to-point, multicast, unicast, or other techniques for exchanging media packets among components in communication system 30. Any network components capable of exchanging audio, video, or other data using frames or packets, are included within the scope of the present invention.

Network 34a may be directly coupled to other IP networks including, but not limited to, another LAN, or the Internet. Since IP networks share a common method of transmitting data, telecommunication signals may be transmitted between telephony devices located on different, but interconnected, IP networks. In addition to being coupled to other IP networks, communication network 34a may also be coupled to non-IP telecommunication networks through the use of interfaces or components, for example gateway 40.

In the illustrated embodiment, communication network 34a is coupled with PSTN 34b through gateway 40. PSTN 34b includes switching stations, central offices, mobile telephone switching offices, pager switching offices, remote terminals, and other related telecommunications equipment that are located throughout the world. IP networks transmit data (including voice and video data) by placing the data in packets and sending each packet individually to the selected destination, along one or more communication paths.

Technology that allows telecommunications to be transmitted over an IP network may comprise Voice over IP (VoIP), or simply Voice over Packet (VoP). In the illustrated embodiment, endpoint 32d, call managers 38a-38b, and gateway 38 are IP telephony devices. IP telephony devices have the ability of encapsulating a user's voice (or other input) into IP packets so that the voice can be transmitted over network 34a. IP telephony devices may include telephones, fax machines, computers running telephony software, nodes, gateways, or any other device capable of performing telephony functions over an IP network.

In particular embodiments, communication system 30 may receive and transmit data in a session initiation protocol (SIP) environment. SIP is an application-layer control protocol that includes primitives for establishing, modifying, and terminating communication sessions. SIP works independently of underlying transport protocols and without dependency on the type of session that is being established. SIP also transparently supports name mapping and redirection services, which support personal mobility.

In particular embodiments, users of endpoints 32a-32d may be identified by components of system 30 according to a uniform reference identifier (URI), such as a user's email address, or other suitable identifier so that a user may be located, monitored, and/or contacted through presence detection technology. Presence detection technology allows end users to maintain a single externally visible identifier regardless of their network location. For example, SIP features enable endpoints 32a-32d to discover one another and to agree on a characterization of a session they would like to share. For locating prospective session participants, and for other functions, SIP enables the creation of an infrastructure of network hosts, such as call managers 38a-38c, to which users of endpoints 32a-32d can send registrations, invitations to sessions, and other requests.

Components of system 30 may capture information about various communication devices, or endpoints, available to a user and their status, such as whether a cellular phone is switched on or whether a user is logged into a personal computer (PC). Specifically, the SIP technology allows users of endpoints 32a-32d to query for the presence of a particular user of an end point. This would provide a presence availability status for the end user, as well as location information, device information, and any personal presence status that the end user wishes to communicate to other end users. Hence, communication system 30 builds on existing SIP capabilities and, further, extends them to provide enhanced information to an end user initiating a communication session with another end user.

In particular embodiments, SIP may also include primitives supporting session setup capabilities. In an example scenario, a first end user of endpoint 32a may desire to establish a communication session with a second end user. As described above, the second end user may be associated with endpoint 32b and endpoint 32c. Communication system 30 may offer an interface on endpoint 32a that may be displayed to the first end user to facilitate the establishment of an optimum call session between the respective parties. Specifically, the interface may display presence information for the second end user. The presence information may identify the endpoints 32b or 32c through which the second user is available for a prospective communication session.

When the first end user desires to establish a communication session with the second end user, the first end user may access presence information for the second end user. Depending upon the particular embodiment implemented, the presence information may be displayed to the first end user over a display associated with endpoint 32a, a computer, or another network device. For example, the displayed presence information indicate that the second end user is available to take a call on endpoint 32b or to receive an instant message or email message on endpoint 32c. The first end user may then select the endpoint 32b or 32c with which the first end user would like to establish the communication session. For example, the first end user may select the telephone of second endpoint 32b and call the number associated with that telephone to communicate with the second end user.

FIG. 2 illustrates a messaging system 44 in more detail, in accordance with a particular embodiment of the present invention. Messaging system 44 includes an interface or input ports 60 which couple messaging system 44 with a communication network 34c. Thus, messaging system 44 may be coupled with any one or more of endpoints 32a-32d to collect and store messages designated for the user(s) of endpoints 32a-32d. Any one or more of endpoints 32a-32d may also be used to access, retrieve, store and/or manipulate stored messages, by any authorized user of messaging system 44. Thus, messaging system 44 typically partitions and stores messages for particular users into various accounts that are accessible by any person that has access and authorization (e.g., username, password).

Processor 66 may be a microprocessor, controller, or any other suitable computing device, resource, or combination of hardware, software and/or encoded logic that allows processor 66 to receive and process messages from/for end users. Processor 66 may also be used to identify authorized users of messaging system 44, and allow access to messages in the account of the authorized user. Processor 66 may also be used to record, store, process, manipulate and/or retrieve messages stored in messaging system 44.

Memory module 70 may be any form of volatile or non-volatile memory including, without limitation, magnetic media, optical media, random access memory (RAM), read-only memory (ROM), removable media, or any other suitable local or remote memory component. In particular embodiments, memory module 70 includes a list for each end user 62 in system 30. Memory module 70 may also be used to store messages of users of messaging system 44 in partitioned accounts associated with those users, such that access to messages of a particular partitioned account is only granted to a user with authorization (e.g., username and password).

Messaging system 44 may also include a presence server 68 that comprises any combination of hardware, software and/or encoded logic, allowing call manager 38b to monitor the presence of an end user at one or more endpoints. In particular embodiments, presence server 68 comprises a single computer or a group of computers that are capable of receiving presence information regarding one or more entities and selectively providing that information to one or more presence watchers. Examples of presence servers include presence servers as defined by IETF specifications. Thus, presence server 68 may cooperate with processor 66 and memory module 70 to provide presence information to end users. The presence information may be used by a first end user to determine the availability of second end user at endpoints 64b and/or 64c, respectively.

Generally, presence server 68 may detect the presence of an end user 62 at an endpoint 64 in association with one or more of presence clients 74 at the end user's endpoint 64, for example, at the end user's PC, phone, personal digital assistant (PDA) or any other presence client device (e.g., presence clients 74a-74d). In particular embodiments, for example, presence clients 74 include software or hardware embodied in a telecommunications switch that determines the hook status of a telephone or other device. In other embodiments, presence clients 74 include software that monitors whether an endpoint 64 comprising a computer is logged into. In still other embodiments, presence clients 74 comprise devices that communicate with an ID tag worn by an end user 62 to indicate the location of the end user 62. However, although particular presence clients 74 are described, a variety of presence clients 74 may be utilized.

FIG. 3 illustrates a method for prioritizing messages of a messaging system (e.g., messaging system 44), in accordance with a particular embodiment of the present invention. The method begins at step 100, where a plurality of messages are received at a messaging system. The messages may be associated with a single account that may be associated with a single user. For example, in the illustrated embodiment, the user may be an executive of an organization and it is anticipated that the executive will receive more messages than the executive is able to efficiently review and/or respond to, in a limited amount of time.

In accordance with the teachings of the present invention, the messages may include voicemail messages that are left by one or more senders. The voicemail messages may include voicemail messages left at one or more voicemail accounts established for the user. For example, any particular user may have more than one telephone number through which the user receives messages. Many users have business telephone numbers, home and/or private telephone numbers, mobile telephone numbers, voicemail accounts and others, through which the user may receive telephone calls and/or messages. Such devices may also be configured to accept messages of other forms, including electronic mail, instant messages, text messages, and/or facsimiles.

Many devices available today are capable of handling various types of communications and/or messages including voice (e.g., audio) and/or electronic text messages. The teachings of the present invention allow the user a great degree of flexibility regarding the type of device used to receive, review and/or respond to messages, and regarding the type and format of the messages the user can receive, review, and/or respond to.

Thus, the number and type of messages received at the messaging system may vary widely within the teachings of the present invention. For example, the messages may include voicemail messages, electronic mail messages, instant messages, text messages, facsimiles and/or other types of communications and messages that the user is capable of receiving.

In accordance with the teachings of the present invention, the messaging system may comprise a Unified Messaging System (UMS) that includes the ability to receive, collect, organize, store, and present all of the various types of messages that a particular user may receive.

At step 102, the messages are stored at the messaging system. Messages may be stored in a particular order, for example in the chronological order in which the messages were received. However, other prioritization schemes are available and may be used in accordance with the teachings of the present invention to determine the initial order in which the messages are stored by the messaging system. The order in which the messages are stored by the messaging system refers to the order in which the messaging system will present the messages to the user or others, through any method including a graphical user interface or an audio communication system in which audio messages (e.g., voicemail messages) may be presented (e.g., played) to the user or another person that is authorized by the user.

The initial order in which the messages are stored may also be based upon a priority of the message that is assigned by either the sender or the user. For example, most electronic mail systems allow a sender to designate that a particular message is a high priority. This allows the message to be marked “urgent” or to include another indication (bold typeface, red color scheme, exclamation point) that the message is particularly important. Unfortunately, the sender's idea of what is of high priority to the user to which the message is addressed often varies widely from what the user and/or the user's assistant may consider to be of high priority.

The order may also rely upon predetermined settings made by the user, regarding the priority of certain messages. For example, a user may indicate that messages sent from a particular sender should receive a higher priority than others. This allows the user to quickly identify or receive messages from an important client, or a manager of the user. Unfortunately, the sender may not know that the user has configured the messaging system to handle all messages from that sender with high importance. Therefore, the sender may leave of message for the user that is not particularly important or critical, and the system will automatically indicate that the message is of high priority. Other methods for establishing the order in which the messages are initially stored include consideration of how other recipients handled the particular message, if the message was sent to more than one user.

At step 104, the messages are presented to an assistant of the user. The assistant will typically have received prior authorization from the user or the messaging system administrator to gain access to the user's message account. This is typically accomplished using a system configuration, authorization and password scheme that confirms the identity of the assistant, and the prior authorization of the user and/or administrator.

In accordance with a particular embodiment of the present invention, the messages are presented to the assistant using a graphical user interface. This allows the assistant to log on to the account from a personal computer, to review messages intended for the user (e.g., an executive for whom the assistant is responsible). In accordance with one embodiment of the invention, the software that accommodates this view is Cisco Unity™. In this manner, email messages, Instant messages and facsimile messages are displayed in a format that allows the user to review certain information (e.g., time received, sender information, subject, etc.) in a summary view, and the entirety of the message text can be reviewed by clicking on an icon associated with the message.

In this embodiment, audio messages (e.g., voicemail messages) are displayed differently than text messages. Certain information regarding the voicemail are displayed on a summary screen, including the time and date received, information regarding the sender, size of message, etc. An icon is also included that allows the assistant (and/or user) to click on the icon and hear the audio message.

Thus, the assistant can review all of the messages at the graphical user interface, and listen to the audio messages as desired. The assistant can choose to review a subset of all of the messages, if the assistant doesn't have time to review all of the messages. This allows the assistant to selectively review the messages based upon certain criteria, including identification of the sender, time received, and any priority (e.g., “urgent”) associated with the message(s).

In an alternative embodiment, the assistant may review the messages using an audio connection only (e.g., over the telephone). Text to speech may be used to convey some or all of the information regarding a particular message and/or contents of the text messages, since the assistant may not have access to a graphical user interface that supports a text display.

At step 106, the assistant assigns a priority scheme to some or all of the messages reviewed by the assistant. It is envisioned that the priority scheme assigned by the assistant may take one or more of many forms, in accordance with the teachings of the present invention.

The priority scheme may include a numerical rank for some, but not all (e.g., a subset) of the messages reviewed by the assistant. For example, the assistant may review a subset of all the messages, and assign a numerical rank to some or all of the subset. The numerical rank may be used to determine the order in which the messaging system will store and/or present (e.g., display through graphical user interface or play audio messages) to the user and/or others that log onto the user's account.

The priority scheme may also include grouping the messages into one or more of a plurality of priority levels. The priority levels help to give the user an indication of the relative importance of particular messages. The priority levels may include high, medium and low, and the messages may be grouped and ordered accordingly. Other priority levels may be available to the assistant, to distinguish between particular types of messages, and allow the user to decide which messages should be reviewed, and in which order. In one embodiment, the messaging system may allow the assistant to designate some of the messages as “personal” to distinguish between business related and personal messages. In still another embodiment, the messaging system may allow the assistant to designate some of the messages with an indication that no action is required of the user. Such messages may be provided for information only, and there is no need for the user to respond or follow up to the message. Such messages would typically fall into a lower priority in the priority scheme. The priority scheme assigned by the assistant is also received by the messaging system at step 106.

At step 108, the messaging system rearranges the messages according to the priority scheme assigned by the assistant, and the messages (and the new order/priority scheme) are stored. In accordance with a particular embodiment of the present invention, the priority scheme may include a numerical ranking of the five most important messages, such that those messages will be presented to the user in that order. The remaining messages may be designated by the categories high priority, medium priority, low priority, personal and no action required, to allow the user to determine which messages to listen to, in the limited amount of time the user has to receive, review and/or respond to messages.

Finally, at step 110, the messages are presented to the user. In one embodiment, the user may establish an audio-only connection with the messaging system (e.g., from a mobile telephone) to receive, review and/or respond to messages. In this embodiment, voicemail messages can be played for the user, according to the priority scheme assigned by the assistant. Also, text messages (e.g., electronic mail, instant messages, facsimile messages, etc) can be played to the user using text to speech technology. Similarly, the user may be provided with an indication of the priority accorded to each of the messages by the assistant, and the user can decide which messages to review and/or respond to, based upon the priority scheme.

In another embodiment, the user may be presented with the messages using a graphical user interface. This can be accomplished if the user has access to a personal computer with network access to the messaging system. In this embodiment, the user will view a screen similar to the one initially reviewed by the assistant, with the exception that the order of the messages will be according to the priority scheme assigned by the assistant.

In accordance with a particular embodiment of the present invention, the messaging system may provide an indication to the user, as to whether or not the assistant has reviewed a particular message. This allows the user to elect to review only those messages that the assistant has already reviewed, to avoid wasting time on messages that may be unimportant (e.g., spam email, telemarketing, or other low priority messages).

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A method for message prioritization, comprising:
receiving a plurality of messages from a plurality of senders and directed to a user of a messaging system;
presenting graphical representations of the messages to an assistant of the user, using a graphical user interface;
receiving, from the assistant, a priority scheme regarding at least a first subset of the plurality of messages; and
storing the priority scheme.

2. The method of claim 1, further comprising:
reorganizing the plurality of messages based, at least in part, upon the priority scheme received from the assistant.

3. The method of claim 1, wherein the priority scheme comprises a numerical ranking of the first subset of the plurality of messages.

4. The method of claim 1, further comprising presenting the first subset of the plurality of messages to the user according to the priority scheme received from the assistant.

5. The method of claim 1, wherein the first subset of the plurality of messages includes voicemail messages, and further comprising:
establishing an audio communication channel between the messaging system and the user; and
playing the voicemail messages to the user according to the priority scheme received from the assistant.

6. The method of claim 3, wherein reorganizing the plurality of messages further comprises grouping messages of a second subset of the plurality of messages into a plurality of priority levels.

7. The method of claim 6, wherein the plurality of priority levels include at least high priority and low priority.

8. The method of claim 1, wherein the priority scheme includes an indication received from the assistant that particular ones of the messages are personal in nature, and further comprising presenting to the user an indication that the particular ones of the plurality of messages are personal in nature.

9. The method of claim 1, wherein the priority scheme includes an indication received from the assistant that particular ones of the messages require no action on the part of the user, and further comprising presenting to the user an indication that the particular ones of the plurality of messages require no action.

10. The method of claim 1, further comprising presenting to the user an indication of which ones of the plurality of messages have been reviewed by the assistant.

11. The method of claim 1, wherein the plurality of messages are received at a Unified Messaging System and wherein the plurality of messages comprise electronic mail messages and voicemail messages.

12. The method of claim 11, wherein the voicemail messages comprise voicemail messages associated with a plurality of different telephone numbers associated with the user.

13. A system for message prioritization, comprising:
an interface operable to receive a plurality of messages from a plurality of senders and directed to a user of a messaging system;
a processor being operable to present graphical representations of the messages to an assistant of the user, using a graphical user interface;
the interface being further operable to receive, from the assistant, a priority scheme regarding at least a first subset of the plurality of messages; and
a memory module being operable to store the priority scheme.

14. The system of claim 13, wherein the processor is further operable to reorganize the plurality of messages based, at least in part, upon the priority scheme received from the assistant.

15. The system of claim 13, wherein the priority scheme comprises a numerical ranking of the first subset of the plurality of messages.

16. The system of claim 13, wherein the processor is further operable to present the first subset of the plurality of messages to the user according to the priority scheme received from the assistant.

17. The system of claim 13, wherein the first subset of the plurality of messages includes voicemail messages, and wherein the processor is further operable to establish an audio communication channel between the messaging system and the user, and play the voicemail messages to the user according to the priority scheme received from the assistant.

18. The system of claim 15, wherein reorganizing the plurality of messages further comprises grouping messages of a second subset of the plurality of messages into a plurality of priority levels.

19. The system of claim 18, wherein the plurality of priority levels include at least high priority and low priority.

20. The system of claim 13, wherein the priority scheme includes an indication received from the assistant that particular ones of the messages are personal in nature, and wherein the processor is further operable to present to the user an indication that the particular ones of the plurality of messages are personal in nature.

21. The system of claim 13, wherein the priority scheme includes an indication received from the assistant that particular ones of the messages require no action on the part of the user, and wherein the processor is further operable to present to the user an indication that the particular ones of the plurality of messages require no action.

22. The system of claim 13, wherein the processor is further operable to present to the user an indication of which ones of the plurality of messages have been reviewed by the assistant.

23. The system of claim 13, wherein the messaging system comprises a unified messaging system and wherein the plurality of messages comprise electronic mail messages and voicemail messages.

24. The system of claim 23, wherein the voicemail messages comprise voicemail messages associated with a plurality of different telephone numbers associated with the user.

25. A system for message prioritization, comprising:
means for receiving a plurality of messages from a plurality of senders and directed to a user of a messaging system;
means for presenting graphical representations of the messages to an assistant of the user, using a graphical user interface;
means for receiving, from the assistant, a priority scheme regarding at least a first subset of the plurality of messages; and
means for storing the priority scheme.

26. The system of claim 25, further comprising means for reorganizing the plurality of messages based, at least in part, upon the priority scheme received from the assistant.

27. The system of claim 25, further comprising means for presenting the first subset of the plurality of messages to the user according to the priority scheme received from the assistant.

28. Logic embodied in a computer readable medium, the computer readable medium comprising code operable to:
receive a plurality of messages from a plurality of senders and directed to a user of a messaging system;
present graphical representations of the messages to an assistant of the user, using a graphical user interface;
receive, from the assistant, a priority scheme regarding at least a first subset of the plurality of messages; and
store the priority scheme.

29. The medium of claim 28, wherein the code is further operable to reorganize the plurality of messages based, at least in part, upon the priority scheme received from the assistant.

30. The medium of claim 28, wherein the code is further operable to present the first subset of the plurality of messages to the user according to the priority scheme received from the assistant.

31. A method for message prioritization, comprising:
receiving a plurality of messages from a plurality of senders and directed to a user of the messaging system;
presenting a representation of the messages to an assistant of the user, using an interface;
receiving, from the assistant, a priority scheme regarding at least a first subset of the plurality of messages; and
storing the priority scheme.

32. The method of claim 31, wherein the representation is selected from the group consisting of a graphical representation and an audio representation.

33. The method of claim 31, wherein the interface is selected from the group consisting of a graphical interface and an audio interface.
